(19) United States
(12) Patent Application Publication
(10) Pub. No.: US 2011/0107030 A1
(43) Pub. Date: May 5, 2011

(54) SELF-ORGANIZING METHODOLOGY FOR CACHE COOPERATION IN VIDEO DISTRIBUTION NETWORKS

(76) Inventors: SIMON BORST, Convent Station, NJ (US); Varun Gupta, Pittsburgh, PA (US); Anwar I. Walid, Watchung, NJ (US)

(21) Appl. No.: 12/608,028

(22) Filed: Oct. 29, 2009

(51) Int. Cl. G06F 12/08; G06F 15/173; G06F 12/00

(52) U.S. Cl. 711/118; 709/223; 711/E12.001; 711/E12.017

(57) ABSTRACT

A content distribution network (CDN) comprising content storage nodes (CSNs) or caches having storage space that preferentially stores more popular content objects.

### FIELD OF THE INVENTION

The invention relates to the field of content distribution networks and, more specifically, to managing content distribution and storage.

### BACKGROUND

Content distribution networks (CDNs) consist of caches that are distributed across the network infrastructure. These caches are typically arranged in hierarchies that follow the underlying network topology. Each cache typically comprises a network element or node having associated with it a mass storage device for storing content. Each cache ordinarily only serves users that are directly attached to the cache; that is, users that are located in the distribution hierachy below the cache. The cooperation between caches is largely limited to the exchange of traffic between parent and sibling caches. In this architecture, all caches at the same level in the hierachy usually have largely the same content. Once they receive a request, they can either serve the requested content directly if stored in the cache (i.e., a cache hit), or if the content is not stored in the cache (i.e., a cache miss), forward the request to a parent cache.

The benefits of cooperative caching have been investigated previously in the setting of distributed file systems. The main rationale for cooperative caching in distributed file systems is that bandwidth is assumed to be abundant, and hence can be freely leveraged to improve response time performance. In web-oriented CDNs such as provided by Akamai Technologies, Inc., Cambridge, Mass., optimizing the response time performance also appears to be the central objective, while limiting the bandwidth consumption only seems to be a secondary aim. In contrast, for high-definition video objects with sizes of a few gigabytes and hour-long durations, minimizing the bandwidth usage is a far more relevant objective than reducing the initial play-out delay by a few hundred milliseconds.

### SUMMARY

These and various other deficiencies of the prior art are addressed by a system, method and apparatus for distributing content objects among a plurality of content storage nodes (CSNs) in a content distribution system (CDS).

In one embodiment, a content distribution system (CDS) comprises a plurality of content storage nodes (CSNs), each CSN comprising a network node adapted for communication with at least one other network node and a storage device for storing content objects; wherein in response to receiving a request for a content object, a CSN preferentially stores the requested content object if a utility value (or demand estimate) associated with the requested content object exceeds the lowest utility value (or demand estimate) associated with one or more content objects presently stored in the storage device.

The utility value of a content object is optionally determined according to the popularity of the content object, which is determined according to content requests received during one or more time periods. The time periods may be one or more of daily, weekly, monthly and quarterly time periods.

In one embodiment, a local cache or content storage node (CSN) includes a local mass storage device. A utility value associated with each content object is monitored and used to determine which content objects will be stored in the mass storage devices within the various caches forming the CDN. The utility value of each content object may be stored at a network manager or other location available to the CSN. The utility value of each content object is optionally updated each time the object is requested. The updated utility value may be used to make local storage content object promotion/demotion determinations.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of a content distribution system (CDS) according to one embodiment;

FIG. 2 depicts a high-level block diagram of a general-purpose computer suitable for use in performing the functions described herein;

FIG. 3 depicts a flow diagram of a storage allocation method according to one embodiment;

FIG. 4 depicts a flow diagram of a storage allocation method according to one embodiment; and

FIG. 5 depicts a flow diagram of a content promotion/demotion method suitable for use in the storage allocation method of FIG. 4.

To facilitate understanding, identical reference numerals have been used, where possible, to designate identical elements that are common to the Figures.

### DETAILED DESCRIPTION

The present invention will be primarily described within the context of a content distribution network (CDN) comprising a hierarchy of content storage nodes or caches in which parent/child (upstream/downstream) communication paths are used to migrate content between caches of the same or different hierarchical levels. It will be appreciated by those skilled in the art that other network topologies including mesh topologies, non-hierarchical topologies, blended hierarchical and nonhierarchical topologies and the like may be used within the context of the present invention.

Various embodiments make content caching decisions based on the values that content items represent globally across the entire cache cluster rather than just the local value. More specifically, when a node receives a request for a content item that it has not presently stored, say item A, it calculates what value that item would provide to the entire cache cluster if it were to be cached (e.g., taking into account the total number of copies that may already be stored by other nodes) and compares that value with that of the lowest-value item that it has currently stored, say item B. If the latter value is lower, then the corresponding item B is evicted and replaced by the requested item A. In different incarnations of the scheme, alternative eviction policies can be adopted, where for example the lowest-value item B could be evicted even if its value is higher than of the requested item A, provided the latter is higher than that of the lowest-value item across the entire cache cluster.

Various embodiments allocate individual cache storage to more popular or “valuable” content, where “value” is defined in terms of value to the local cache memory, local cache cluster and/or CDN as a whole. Value is calculated using one or more of a plurality of parameters such that relative “value” of one content item or object to another may be assessed. Based on this assessment, one or more presently stored content objects may be “evicted” (i.e., removed from) cache memory so that one or more other content objects may be stored in the cache memory. Parameters indicative of content popularity are monitored and, effectively, used to migrate content between the various caches forming the CDN.

Various embodiments described herein provide relatively lightweight cooperative content placement algorithms adapted to maximize the traffic volume served from a cache and thus minimize the bandwidth cost. The bandwidth cost need not be actual monetary expenses, but could also represent some QoS metric reflecting the congestion levels on the various network links, like link weights in Open Shortest Path First (OSPF) for example.

Various embodiments will be described within the context of a cluster of distributed caches, either connected directly or via a parent node. It is noted that a cache cluster need not be a standalone network, but could in fact be part of a larger hierarchical tree topology. For ease of operation, IPTV networks tend to have a mostly hierarchical tree structure, but they may also have some degree of logical connectivity among nodes within the same hierarchy level, either directly or via a “U-turn” through a common parent node. Cost analysis reveals that it rarely pays off to install caches at more than one or two levels, even if the network consists of four or five hierarchy levels as is commonly the case. Also, there are implementation issues involved in integrating caches with other lower-layer devices at certain hierarchy levels. Hence, the two-level cache cluster constitutes a fairly canonical scenario that covers most cases of practical interest. However, most of the embodiments described herein are applicable to any number of hierarchy levels.

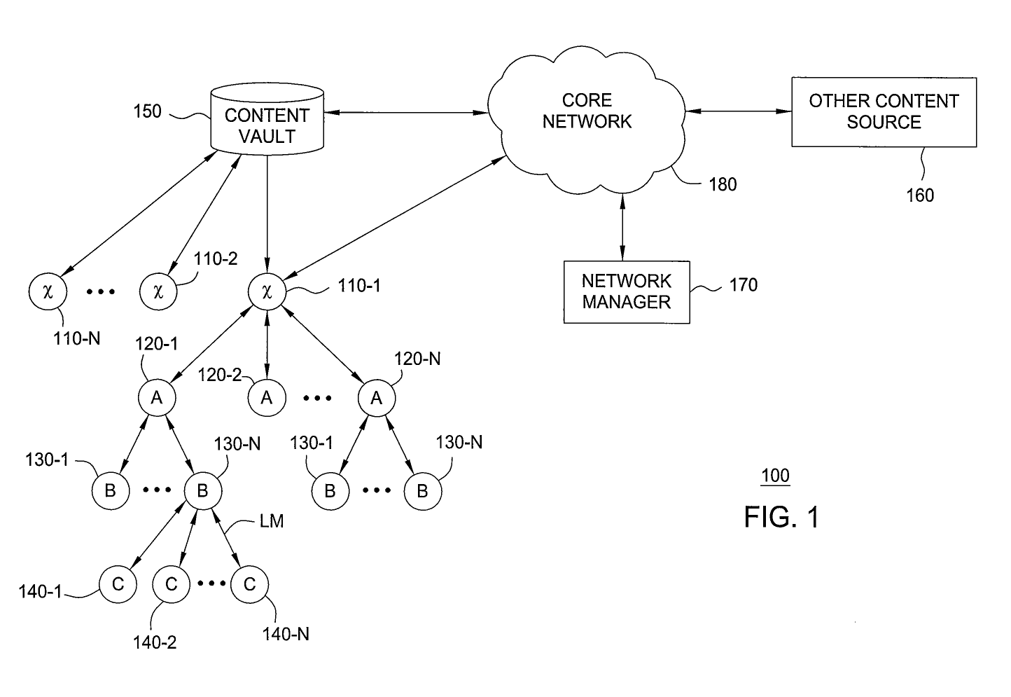

FIG. 1 depicts a high-level block diagram of a content distribution system (CDS) according to one embodiment. The CDS 100 of FIG. 1 operates to distribute content such as movies, television programs, music and the like. Generally speaking, content objects or items are initially stored in a content vault or provided by some other content source, such as a remote server or cache within the CDS.

Specifically, the content distribution system 100 of FIG. 1 comprises a plurality of central or top-level content aggregation nodes 110-1 through 110-N (collectively content aggregation nodes 110) that receives content from any of a content vault 150 or other content sources 160. Each content aggregation node 110 distributes content to each of a plurality of second-level network elements operating as content storage nodes, denoted as network elements 120-1 through 120-N (collectively second-level network elements 120). Each of the second-level network elements 120 distributes content to a respective plurality of third-level network elements operating as content storage nodes, denoted as network elements 130-1 through 130-N (collectively third-level network elements 130). Each of the third-level network elements 130 distributes content to a respective plurality of client devices, denoted as 140-1 to 140-N (collectively client devices 140).

The content aggregation node 110, second-level network elements 120 and third-level network elements 130 collectively represent an access network suitable for enabling access to a core network 180 by the client devices 140 as needed.

The content vault 150 is depicted as communicating with the content aggregation node 110 directly and/or via the core network 180, while the other content sources 160 are depicted as communicating with the content aggregation node 110 via the core network 180.

Also depicted is a network manager 170 in communication with the core network 180. The network manager 170 operates in various embodiments as a content manager that is adapted to manage space allocations within mass storage devices of a plurality of content caches.

It will be appreciated by those skilled in the art that while the network manager 170 is depicted as communicating only with the core network 180, the network manager 170 may communicate with any suitable network element within the network being managed, such as content aggregation node 110. Moreover, while depicted as a distinct element, the network manager 170 may be included within any of the content aggregation node 110, second-level network elements 120 and third-level network elements 130.

While described within the context of a hierarchical CDN, various other embodiments include communication paths between multiple levels of different hierarchical branches, communication paths between network elements of the same hierarchical level (i.e., peer-to-peer paths) and so on. The remainder of the discussion of FIG. 1 will focus primarily on a hierarchical branch emanating from a single content aggregation node 110 (i.e., content aggregation node 110-2). Similarly, while only two hierarchical levels of content storage nodes are depicted (120/130), more or fewer hierarchical levels of content storage nodes may be used within the context of the various embodiments. In addition, the use of the term “plurality” as it relates to the number of content storage nodes, client devices and the like should not be construed as indicative of a specific number. For example, the plurality N of second-level network elements 120 does not need to be the same as the plurality N of third-level network elements 130 and/or plurality N of client devices 140.

Content aggregation node 110 conveys content to each of the second-level content storage nodes 120. Second-level content storage nodes 120 communicate with corresponding third-level content storage nodes 130. Third-level content storage nodes 130 communicate with their respective neighborhoods of client devices 140.

In one embodiment related to telecommunication networks, the content vault 150 comprises a Video Hub Office (VHO), each of the content aggregation nodes 110 comprises an intermediate-office (IO) communication center, each of the second-level content storage nodes 120 comprise a central office (CO), each of the third-level content storage nodes 130 comprises a digital subscriber line access multiplexer (DSLAM), and each of the client devices 140 comprises a set top box (STB). In other embodiments relating to cable television networks, the comparable cable television network devices are utilized (e.g., the content aggregation nodes comprise cable-television head end devices and the like).

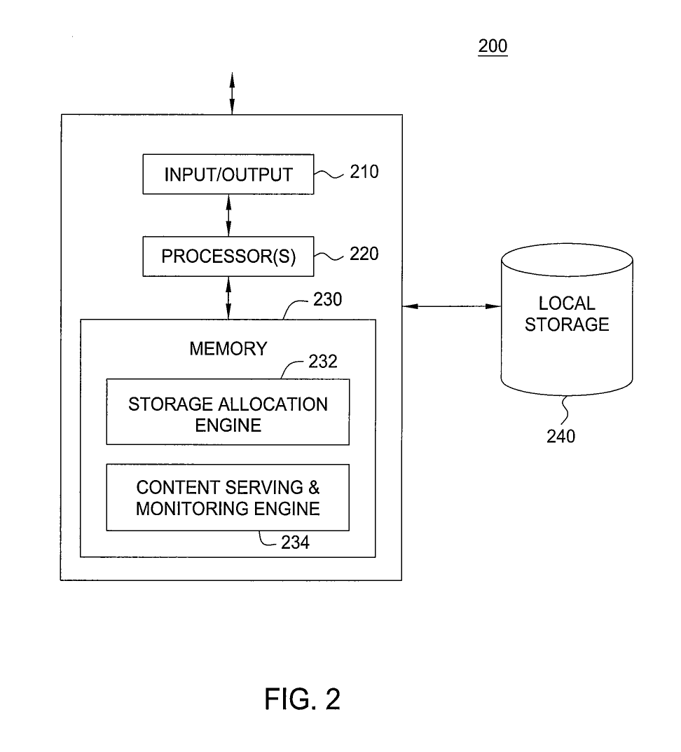

Each of the content storage or distribution nodes 110/120/130 is associated with one or more mass storage devices for storing or caching content objects. An exemplary arrangement of a content storage node will be discussed in more detail below with respect to FIG. 2.

In normal operation, a client device 140 requests content from the content storage node 130 serving a client device. If the mass storage device associated with the content storage node 130 includes requested content, then the content is served directly to the client device. If not, then the content must be retrieved from another content storage node, the content aggregation node 110, the content vault 150 or some other content source 160. In the latter case, the user experience is somewhat degraded by the amount of time necessary to retrieve and serve the requested content, and additional network bandwidth is consumed.

Each content object within the content distribution system has associated with it a utility value. The utility value is based upon one or more of the following factors: popularity of a content object (e.g., measured by local and/or total requests, optionally grouped by age), file size of a content object, location of a content object, cost to retrieve a content object from a nearest cache or cache cluster and other factors. These factors are optionally weighted with respect to each other. An exemplary set of utility factor parameters is provided below with respect to Table 1. It will be appreciated by those skilled in the art that more or fewer utility parameter factors may be employed within the context of the various embodiments.

TABLE 1

| | Weight | Content | Content | Content |
|---|---|---|---|---|
| Utility Parameter Factors | Factor | 1 | 2 | 3 |
| File Size | | | | |
| Number of caches in cluster | | | | |
| storing content | | | | |
| Cost of transport from nearest | | | | |
| storing cache | | | | |
| Number of clusters in network | | | | |
| storing content | | | | |
| Cost of transport from nearest | | | | |
| storing cluster | | | | |
| Local Requests Today | | | | |
| Local Requests 2-3 Days Ago | | | | |
| Local Requests 4-5 Days Ago | | | | |
| Local Requests 6-7 Days Ago | | | | |
| Local Requests Last Week | | | | |
| Local Requests 2 Weeks Ago | | | | |
| Local Requests 3 Weeks Ago | | | | |
| Local Requests 4 Weeks Ago | | | | |
| Local Requests Last Month | | | | |
| Local Requests 2 Months Ago | | | | |
| Local Requests 3 Months Ago | | | | |
| Local Requests 2 Quarters Ago | | | | |
| Local Requests 3 Quarters Ago | | | | |
| Local Requests 4 Quarters Ago | | | | |
| Total Requests Today | | | | |
| Total Requests 2-3 Days Ago | | | | |
| Total Requests 4-5 Days Ago | | | | |
| Total Requests 6-7 Days Ago | | | | |
| Total Requests Last Week | | | | |
| Total Requests 2 Weeks Ago | | | | |
| Total Requests 3 Weeks Ago | | | | |
| Total Requests 4 Weeks Ago | | | | |
| Total Requests Last Month | | | | |
| Total Requests 2 Months Ago | | | | |
| Total Requests 3 Months Ago | | | | |
| Total Requests 2 Quarters Ago | | | | |
| Total Requests 3 Quarters Ago | | | | |
| Total Requests 4 Quarters Ago | | | | |

Various embodiments adapt the specific content objects stored locally in response to changes in the utility values associated with available content objects. Content storage space is finite, thus a rank ordered list of content objects based upon relative utility is employed to determine which content objects are stored locally. If a content object becomes less popular over time (e.g., relative utility decreases), it may be “expelled” from the cache space. Similarly, if a content object becomes more popular over time (e.g., relative utility increases), it may be “promoted” and included in the cache space. Generally speaking, more popular and therefore more frequently requested content objects or titles will tend to have a higher utility value such that these content objects or titles will tend to be stored in the cache space. In this manner, very popular content objects such as new movies, television programs, sporting events, music and the like will tend to be locally stored for more rapid streaming to requesting users and reducing the overall bandwidth consumption in the network.

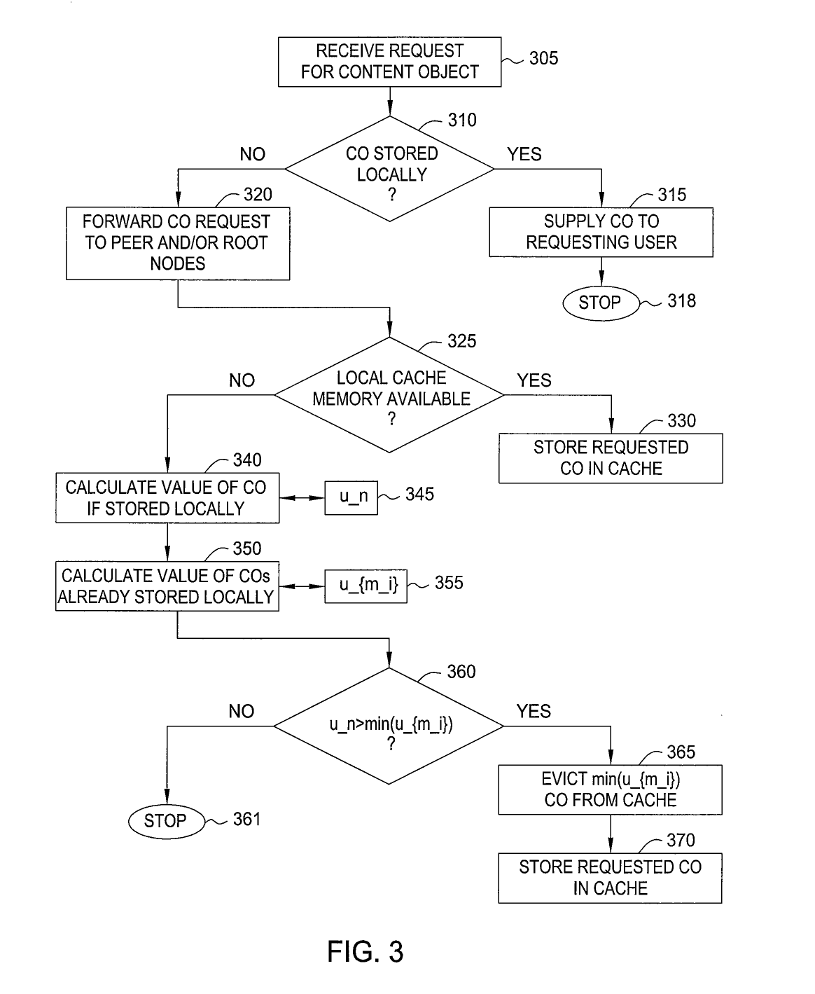

In various embodiments, the network manager 170 stores data such as defined in Table 1 for each content object at each content storage node (CSN). When a requested content object is not available at the CSN receiving the request, a procedure is executed for determining whether the requested content should replace existing content stored at the CSN. One such procedure is discussed below with respect to FIG. 3.

Preferences in space allocations may be imparted to the CDN via the network manager 170. Specifically, the network manager 170 optionally adapts the operation of content storage nodes by, illustratively, adapting the relative weighting of factors used to define a utility value associated with each content object. In this manner, storage allocation methodologies may be adapted in response to changes in network performance and/or cost criteria.

FIG. 2 depicts a high-level block diagram of a general-purpose computer suitable for use in performing the functions described herein. Specifically, the system 200 includes one or processing elements 220 (e.g., a central processing unit (CPU)), a memory 230, e.g., random access memory (RAM) and/or read only memory (ROM) and various input/output devices 210 (e.g., storage devices, including but not limited to, a tape drive, a floppy drive, a hard disk drive or a compact disk drive, a receiver, a transmitter, a speaker, a display, an output port, the communications network interface and a user input device (such as a keyboard, a keypad, a mouse, and the like)). In addition, a local storage device 240 is depicted, such as one or more mass storage devices, such as hard disk drives, disk drive arrays and the like.

The system 200 is a simplified representation of basic computing elements useful in implementing the various functions described herein with respect to the content, content storage nodes 120/130 and/or client devices 140 depicted above with respect to FIG. 1. The memory 230 is depicted as including a storage allocation 232 and a content serving and monitoring engine 234. In various embodiments, the storage allocation engine 232 comprises software instructions executed by one or more of the content storage nodes 120/130 to implement the various methods described herein. In various embodiments, the content serving and monitoring engine 234 comprises software instructions executed by the content aggregation node 110, network manager 170 and/or a distribution node 120/130 to implement the various methods described herein.

It is contemplated that some of the steps discussed herein as software methods may be implemented within hardware, for example, as circuitry that cooperates with the processor to perform various method steps. Portions of the present invention may be implemented as a computer program product wherein computer instructions, when processed by a computer, adapt the operation of the computer such that the methods and/or techniques of the present invention are invoked or otherwise provided. Instructions for invoking the inventive methods may be stored in fixed or removable computer readable media, transmitted via a data stream in a broadcast or other signal bearing medium, and/or stored within a working memory within a computing device operating according to the instructions. Thus, one embodiment comprises an apparatus including a memory for storing software instructions and a processor for executing the software instructions, wherein the software instructions when executed by the processor cause the apparatus to perform one or more methods according to the various embodiments discussed herein.

FIG. 3 depicts a flow diagram of a storage allocation method according to one embodiment. The storage allocation method 300 is suitable for use within, for example, a content storage node such as described above with respect FIG. 1.

At step 305, a request for a particular content object is received at a cache or content storage node (CSN).

At step 310, a determination is made as to whether the content object is stored locally. If the content object is stored locally, then at step 315 the requested content object is supplied/streamed to the requesting user in a method 300 is exited at step 318.

If the content object is not stored locally, then at step 320 the content object request is forwarded to other nodes, such as other nodes within the cache cluster, peer nodes, parent nodes and/or root node. While not shown in detail, a node receiving a content object request will begin streaming the requested content object to the requesting user via, typically, the content storage node that originally received the user request. As such, this initial content storage node may store the requested content object locally if sufficient local memory space exists or can be made to exist via deleting one or more presently stored content objects.

At step 325, a determination is made as to whether sufficient local cache memory is available to store the requested content object. If sufficient memory is available, then at step 330 the requested content object is stored in local cache memory. This process of storing the content object in local cache memory may occur as a capture of the content object as it is streamed to the requesting user. If sufficient memory to store the requested content object is not available, then the method 300 proceeds to step 340.

At step 340, a utility value of the requested content object n at node i is calculated. Referring to box 345, a utility value u_in is calculated for the requested content object. Exemplary techniques for calculating the utility value u_in will be described in more detail below. At step 350, utility values are calculated for each of the of the content objects already stored in the local cache memory. Referring to box 355, utility values are calculated for each of the content objects already stored in the local cache memory. In particular, the content object m_i with the minimum utility value among all currently stored objects in node i is determined. Exemplary techniques for calculating the utility values will be described in more detail below. As previously noted, the utility value of a content object is based upon one or more of the following factors: popularity of a content object (e.g., measured by local and/or total requests, optionally grouped by age), file size of a content object, location of a content object, cost to retrieve a content object from a nearest cache or cache cluster and other factors. These factors are optionally weighted with respect to each other.

At step 360, a determination is made as to whether the utility value u_in associated with the requested content object is greater than the minimum utility value u_{im_i} of the content objects already stored in the local cache memory.

If the requested content object utility value u_in is greater than the minimum utility value u_{im_i} of the content objects already stored, then at step 365 the content object m_i stored in the cache memory having the minimum utility value is evicted (i.e., deleted). At step 370, the requested content object is stored in the local cache memory.

If the requested content object utility value u_in is not greater than the minimum utility value u_{im_i} of the content objects already stored, then at step 361 the method 300 is exited.

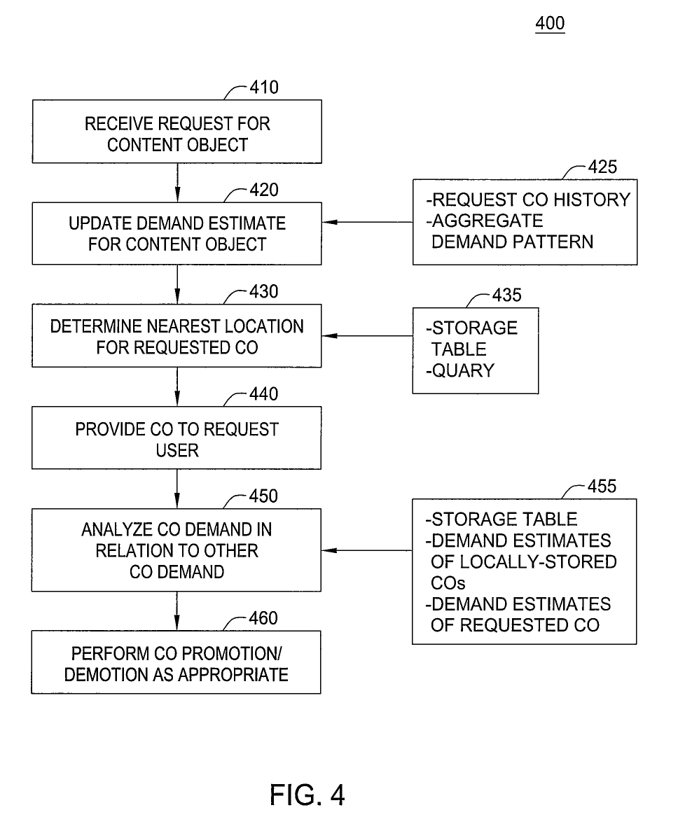

FIG. 4 depicts a flow diagram of a storage allocation method according to one embodiment. The storage allocation method 400 is suitable for use within, for example, a content storage node such as described above with respect FIG. 1.

At step 410, a request for a particular content object (CO) is received at a cache or content storage node (CSN).

At step 420, a demand estimate associated with the requested content object is updated. That is, referring to box 425, data structures such as depicted above with respect to Table 1 are updated to reflect changes in the request history of the content object, the aggregate demand pattern and/or other parameters.

At step 430, the location of the nearest (with respect to the CSN receiving the CO request) storage location including the requested CO is determined. Referring to box 435, the nearest location may be determined by referencing a storage table, by querying a manager and/or other means. The storage table may be available locally or may be remotely accessible (e.g., at a network management node or content cache management node).

At step 440 the requested content object is supplied/streamed to the requesting user.

At step 450, an analysis of the demand/utility for the requested CO in comparison to the demand/utility of other COs is performed. Referring to box 455, the analysis is performed with respect to one or more of a storage table, demand estimates of locally stored COs, demand estimates of other requested COs and/or other techniques useful in ranking the relative demand or utility of the requested CO with respect to other COs, such as those COs presently stored in the CSN.

At step 460, a content object promotion/demotion operation is performed. In one embodiment, the content objects stored locally are modified based on the analysis performed at step 460. To ensure that the highest demand/utility content objects are stored locally, the lower demand/utility content objects are deleted from local storage and replaced with the higher demand/utility content objects.

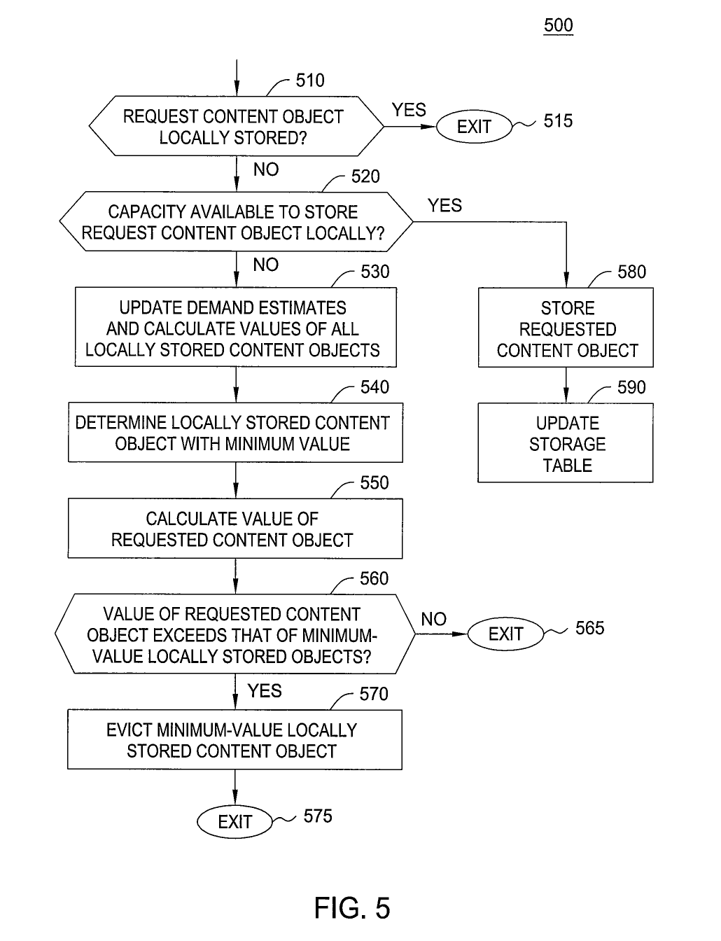

FIG. 5 depicts a flow diagram of a content promotion/demotion method suitable for use in the storage allocation method of FIG. 4. The method 500 is entered at step 510, where a determination is made as to whether the requested content object is stored locally. If so, then the method 500 exits at step 515. If not, then a determination is made as to whether sufficient local storage capacity is available to store the requested content object locally. If so, then at step 580 the requested content object is stored locally, and at step 590 the storage table is updated to reflect the local storage of the requested content object and/or the additional demand for the requested content object.

If local storage capacity is insufficient to store the requested CO then the demand estimates and calculated utility values of the content objects presently stored locally are updated.

At step 540, a determination is made as to which one or more locally stored content objects has a minimum utility value. At step 550, the utility value of the requested CO is calculated.

At step 560, a determination is made as to whether the utility value of the requested content object exceeds the utility value of the minimum utility value content object. If not, then the method 500 exits at step 565. If so, then the minimum utility value content object(s) is evicted (deleted) from local storage and the requested content object is stored in local storage. The method 500 exits at step 576.

The above descriptions generally assume that the sizes of all content objects are equal. In various embodiments the size of a content object is taken into consideration when determining whether or not to store the content object in the local cache memory. For example, where a relatively large content object would displace multiple relatively small content objects in local storage, the relatively large content object is stored/promoted only if the utility value of the relatively large content object exceeds the aggregate utility level of the relatively smaller content objects to be displaced/demoted. Content object size may be utilized as a decision factor in each embodiment described herein. Generally speaking, if the size of the requested content object exceeds that of the one or more minimum utility value content object(s), then additional stored content objects are deleted if their aggregate utility value is less than the utility value of the requested content object.

Referring to FIG. 1, the CDN system may be abstracted at several locations as a root node (e.g., aggregation node 110) in communication with one or more parent nodes (e.g., second-level content storage nodes 120), which are in communication with one or more leaf nodes (e.g., third-level content storage nodes 130). This root/parent/leaf hierarchy may also be abstracted or conceptualized as content vault 150/content aggregation node 110/second-level content stores and 120. Another root/parent/leaf hierarchy may be abstracted or conceptualized as second-level content storage node 120/third-level content storage node 130/client device 140.

Consider a cache cluster consisting of M leaf nodes indexed 1, . . . , M, which are either directly connected or indirectly via a common parent node labeled 0 somewhere along the path to the root node.

The parent node and leaf nodes are endowed with caches of sizes B_0, B_1, . . . , B_M, while the root node is endowed with a cache of sufficient capacity to store all the content items. For simplicity, assume that B_{—}0=0, though the methodology extends to situations where the parent node has a cache as well.

Assume that a system offers a static collection of N content items. Denote by d_in the demand (estimate) for content object n in node i. For ease of exposition, assume unit-size content objects, though the algorithms easily extend to arbitrary sizes.

The parameters g_i and c_ij represent the unit bandwidth cost incurred when transferring content from the root node to node l and from node j to node i, respectively.

In one embodiment, the utility value of a requested content object is calculated as follows:

(1) u_n=d_in c_{ijopt} if the copy of object n is fetched from the cheapest peer node jopt (i.e., if object n is already currently stored elsewhere in the cluster); or

(2) u_n=d_in g_i+sum_{j not equal i} d_jn (g_j−c_{ji}) if the copy of object n is furnished by the root node, (i.e., if object n is presently not stored anywhere else in the cluster).

Node i also computes the values associated with all the objects that it has currently stored in the same manner as described above for object n, and identifies the object m_i that represents the minimum value.

If u_{im_i}<u_in, then object m_i is evicted, and replaced by object n, caching the corresponding data as it flows through node i. Otherwise, no further action is taken.

For homogeneous bandwidth costs, the above-described methodology will achieve a fraction ¾ of the maximum bandwidth savings for symmetric demands and a fraction ½ for arbitrary demand vectors. Numerical experiments show that for typical popularity distributions the actual performance is far better than the worst-case ratios indicate, and in fact nearly indistinguishable from optimal.

In different embodiments, alternative eviction policies can be adopted, where for example the minimum-value object m_i in the cache of node i could be evicted and replaced by the requested object n, even if u_in<u_{im_i}, provided that u_in>min{u_{—}{1m_{—}1}, . . . , u_{Mm_M}}>c′d_{m_i}.

The methods described herein operate to incrementally and/or gradually adapt the content objects stored within a mass storage device in response to changes in content popularity. Those content objects tending to be extremely popular will over time be stored in the cache of content storage nodes. Those content objects tending to be extremely unpopular will over time be removed from the cache of content storage nodes and stored only at a content vault or other non-cached location.

One embodiment provides an improved cache management scheme wherein the operation of content caches at multiple content storage nodes is adapted to gradually move from individualized caching to cooperative caching of content within the content distribution network (CDN). In this manner, improved caching efficiency from reducing duplication of content is balanced against an improved efficiency from increasing duplication of locally popular content. That is, while full cache cooperation significantly reduces the bandwidth towards the original server (which directly translates to bandwidth savings on the peering links of an Internet service provider), full cache cooperation does increase the amount of traffic exchanged between caches. By intelligently selecting the relevant parameters of cache cooperation, such as the bandwidth costs among nodes, a CDN according to the various embodiments leverages its available resources to reduce peering links.

In various embodiments, a U-turn configuration is provided in which content storage nodes utilize normally unused bandwidth to redistribute content.

This invention provides significant advantages to network operators supporting content dissemination and/or distribution who are able to place storage devices inside the network and have knowledge of the underlying network topology. The benefits include savings in cost of bandwidth, increased usage of unused resources, and improved service to their customers.

The proposed solution takes advantage of the cooperation of a distributed set of cache nodes inside the network along with the knowledge of the underlying network topology to reduce the cost of transit bandwidth by leveraging the use of disk space and unused uplink capacity.

In another embodiment, a sudden increase in the global popularity of a given object will result in keeping multiple copies of it across the network. Each copy will be stored in a node's local cache, which will relieve the traffic from the source node and will allow the network to adapt to such a sudden change in traffic pattern, while keeping low response times, low bandwidth consumption, and enhanced responsiveness.

Advantageously, the above caching strategies provide an effective mechanism for mitigating the massive bandwidth requirements associated with large-scale distribution of personalized high-definition video content in IPTV networks. The reduction in the traffic load translates into smaller required transport capacity and capital expense as well as fewer performance bottlenecks, thus enabling better service quality, e.g., short and predictable download times, at a lower price. The algorithms and methodologies described herein operate in a largely distributed fashion and involve limited communication overhead, making them well-suited for practical implementation, and yet closely approach globally optimal performance.

Although various embodiments which incorporate the teachings of the present invention have been shown and described in detail herein, those skilled in the art can readily devise many other varied embodiments that still incorporate these teachings.

What is claimed is:

1. A content distribution system (CDS) for distributing a plurality of available content objects, comprising:
a plurality of content storage nodes (CSNs), each CSN comprising a network node adapted for communication with at least one other network node and a storage device for storing content objects; wherein
in response to receiving a request for a content object, a CSN preferentially stores the requested content object if a utility value associated with the requested content object exceeds the lowest utility value associated with one or more content objects presently stored in the storage device.

2. The system of claim 1, wherein the utility value of a content object is determined according to the popularity of the content object, said popularity being determined according to content requests received during one or more time periods.

3. The system of claim 2, wherein the time periods associated with content requests comprise one or more of daily, weekly, monthly and quarterly time periods.

4. The system of claim 3, wherein said content requests used to determine popularity comprise requests to the CDN from which the content object was requested.

5. The system of claim 3, wherein said content requests used to determine popularity comprise requests to any content storage nodes within a cluster of content storage nodes including the CDN from which the content object was requested.

6. The system of claim 3, wherein said content requests used to determine popularity comprise requests to all content storage nodes within the CDN.

7. The system of claim 2, wherein the utility value of the content object is further determined according to the file size of the requested content object.

8. The system of claim 2, wherein the CSN receiving the content object request in included within a cluster of CSNs, the utility value of the content object being further determined according to a number of CSNs within the cluster storing the requested content object.

9. The system of claim 2, wherein the utility value of the content object is further determined according to a cost of transporting the content object from nearest cluster storing the content object.

10. The system of claim 1, further comprising a content vault for storing content objects for distribution via the content aggregation node.

11. The system of claim 1, further comprising a content manager adapted to manage space allocations within CSN storage devices.

12. The system of claim 1, wherein in response to a request for a content object not stored in a CSN, the requested content object replaces one or more less popular content objects presently stored in a local space of the CSN.

13. A method for allocating storage resources in a content distribution system (CDS) including a plurality content storage nodes (CSNs), the method comprising:
receiving at a CSN a request for a content object;
updating a demand estimate associated with the requested content object; and
preferentially storing the content object at the CSN if the demand estimate associated with the requested content object exceeds the demand estimate of a content object presently stored at the CSN.

14. The method of claim 13, wherein the demand estimate of the requested content object is updated based upon one or more of a requested content object history and an aggregate demand pattern.

15. The method of claim 13, wherein said preferential storage of the requested content object is performed by analyzing a storage table including information pertaining to content object demand estimates for at least the requested content object and the content objects presently stored in the CSN.

16. The method of claim 15, wherein the storage table is located in at one of a network management node and a content cache management node.

17. The method of claim 13, wherein the step of preferentially storing comprises:
if the CSN has sufficient available capacity, then storing the requested content object at the CSN;
if the CSN does not have sufficient available capacity and if the demand estimate associated with at least one presently stored content objects is less than the demand estimate of the requested content object, then deleting from the CSN at least one of the less demanded presently stored content objects and storing the requested content object at the CSN.

18. In a content distribution system (CDS) comprising a plurality of content storage nodes (CSNs), each CSN including a storage device, a method for adapting the storage of content, comprising:
receiving a content object request at a CSN;
replacing a content object stored in the CSN with the requested content object if a utility level of one or more stored content objects is less than a utility level of the requested content object.

19. The method of claim 18, wherein the replacement content object is transmitted via a parent CSN.

20. A computer readable medium storing a software program that, when executed by a computer, causes the computer to perform a method for adapting the storage of content, the method comprising:
receiving a content object request at a content storage node (CSN) within a content distribution system (CDS) comprising a plurality of CSNs, each CSN including a storage device;
replacing a content object stored in the CSN with the requested content object if a utility level of one or more stored content objects is less than a utility level of the requested content object.
